(19) United States
(12) Patent Application Publication
(10) Pub. No.: US 2012/0176078 A1
(43) Pub. Date: Jul. 12, 2012

(54) SOLAR CHARGEABLE BATTERY FOR PORTABLE DEVICES

(75) Inventors: PETER ENGLISH, Aliso Viejo, CA (US); Steven R. Brimmer, Thousand Oaks, CA (US)

(73) Assignee: SunCore Corporation, Irvine, CA (US)

(21) Appl. No.: 13/348,208

(22) Filed: Jan. 11, 2012

Related U.S. Application Data
(63) Continuation of application No. 12/389,332, filed on Feb. 19, 2009, now abandoned.

(51) Int. Cl. H01M 10/46; H02J 7/00

(52) U.S. Cl. 320/101; 320/107

(57) ABSTRACT

A solar chargeable battery comprises a built-in photovoltaic array and a programmable battery charging circuit. The photovoltaic array provides a variable power source in response to light. The battery charging circuit receives the variable power source and operates in different modes to charge the battery over a range of lighting conditions. For example, the battery charging circuit charges the battery to a substantially fixed regulated voltage level in a first mode when a voltage level of the variable power source is above a predefined threshold. The battery charging circuit charges the battery to an adjustable regulated voltage level in a second mode when the voltage level of the variable power source is below the predefined threshold.

### CROSS-REFERENCE TO RELATED APPLICATIONS

This application is a continuation of U.S. patent application Ser. No. 12/389,332, filed Feb. 19, 2009 entitled “SOLAR CHARGEABLE BATTERY FOR PORTABLE DEVICES”, which is hereby incorporated by reference in its entirety.

### BACKGROUND

1. Field

This disclosure relates generally to battery charging circuits and solar chargeable replacement batteries for portable devices.

2. Description of the Related Art

Portable communication and entertainment devices (e.g., laptop computers, cameras, cell phones, PDAs, GPS units, music player devices, and other hand-held devices) typically have battery packs that are recharged through tethered charging systems (e.g., AC adapters or USB interfaces). The tethered charging systems limit mobility and may inconvenience users. Batteries can also be charged using solar energy. For examples, photovoltaic (PV) cells can absorb energy from electromagnetic waves and convert photon energy into electrical energy for charging a battery. However, the PV cells generally cannot provide a continuously stable energy source like the tethered charging systems. That is, the electrical energy from the PV cells fluctuates when lighting conditions change and charging the battery becomes a challenge.

### SUMMARY

In one embodiment, the present invention solves this and other problems by using a battery charging circuit (or charge management circuitry) that continuously manipulates a rate or amount of charge from PV cells based on varying light conditions to charge a battery. For example, the battery charging circuit includes a power regulator configured to receive a variable DC power source at an input terminal and to charge the battery coupled to an output terminal. In some implementations, the power regulator is a DC-DC switching regulator such as a synchronous buck converter. The variable DC power source can be provided by one or more PV cells. In one implementation, the variable DC power source comprises at least two PV cells connected in series.

The battery charging circuit also includes a controller that monitors or senses the variable DC power source and selectively operates the power regulator in a first mode or a second mode based on a voltage level of the variable DC power source. For example, the controller provides one or more control signals to the power regulator to selectively operate the power regulator in the first mode when the variable DC power source is above a first predefined voltage threshold indicative of relatively bright light conditions and in the second mode when the variable DC power source is below the first predefined voltage threshold indicative of relatively low light conditions. The relatively bright light conditions may occur when the PV cells are exposed to direct sunlight or bright indoor lights. The relatively low light conditions may occur when the PV cells are partially covered, in shadows, or exposed to dim indoor lights.

The power regulator operates with a predetermined regulated voltage level in the first mode and operates with an adjustable regulated voltage level in the second mode. That is, the power regulator charges the battery to the predetermined regulated voltage level in the first mode and charges the battery to the adjustable regulated voltage level in the second mode. In one application, the battery is a lithium based battery and the predetermined regulated voltage is about 4.2V. In the second mode, the adjustable regulated voltage level tracks the voltage level of the variable DC power source and is approximately equal to the voltage level of the variable DC power source less a predetermined amount. The different modes of operation allow the power regulator to efficiently charge or recharge the battery under various light conditions. The adjustable regulated voltage level also allows the power regulator to continue providing accurate (or well-controlled) voltage regulation and current regulation over a range of lighting conditions.

In one embodiment, the battery charging circuit charges the battery using a constant-current/constant-voltage (CC/CV) algorithm comprising interleaving current regulation phases and voltage regulation phases. The battery charging circuit provides a substantially constant battery charging current during the current regulation phases to increase battery voltage to a desired level. The battery charging circuit provides a decreasing battery charging current during the voltage regulation phases to maintain the desired level of battery voltage. The battery stops charging in the voltage regulation phases when the decreasing battery current reaches a termination current level. In one embodiment, the termination current level is a programmable parameter that is stored in the controller using a standard interface (e.g., JTAG interface). Other battery parameters, such as the predetermined regulated voltage level, are also programmable and similarly stored in the controller using the standard interface.

In some applications, the substantially constant battery charging current has a predetermined current level when a current level of the variable DC power source is above a predefined current threshold. The substantially constant battery charging current has an adjusted current level that tracks or is approximately equal to the current level of the variable DC power source when the current level of the variable DC power source is below the predefined current threshold. To reduce electromagnetic interference (EMI) in some applications, the substantially constant battery charging current has a stepped rising edge near a beginning of each current regulation phase. For example, the stepped rising edge may comprise a plurality of incremental current steps with programmable step sizes and intervals to implement configurable and controlled rising edges for the battery charging current.

In one embodiment, the battery charging circuit is part of a solar chargeable replacement battery package for a portable device. The solar chargeable replacement battery package is an encapsulated package having a substantially similar form factor as a standard battery specified by a manufacturer of the portable device. The encapsulated or self-contained package includes a battery placed on a bottom surface, a PV array placed on top of the battery and isolated from the battery by a thermal barrier layer, and a clear protective layer placed on top of the PV array. The clear protective layer forms a top surface of the encapsulated package. The solar chargeable replacement battery package may be part of a kit that further includes a replacement cover with a central opening. When the solar chargeable replacement battery package is installed in the portable device, the clear protective layer faces outward and is exposed through the central opening of the replacement cover for the portable device such that light can reach the PV array to generate electricity. In one embodiment, the battery charging circuit occupies a portion of the battery layer and electrically interfaces the battery layer to the PV array.

In some applications directed to mobile communication devices such as cell phones, the battery layer is approximately 3.5 mm thick and comprises a lithium-ion or a lithium-polymer battery. The thermal barrier layer comprises a polyimide film with a thickness of approximately 25 μm-50 μm. The PV array comprises one or more single-junction or multi-junction PV cells having a thickness of approximately 140 μm. The clear protective layer has a thickness of approximately 70 μm-90 μm. Other dimensions are possible to achieve application specific form factors for the solar chargeable replacement battery package.

In one embodiment, the battery charging circuit includes a status diode electrically coupled between the PV array and a status pin of the power regulator. The status diode is positioned in the encapsulated package to provide a visible light on an outer surface to indicate when the battery is being charged by the PV array. In some implementations, the power regulator and the controller enter a sleep mode when the voltage provided by the PV array is less than a second predefined voltage threshold. The battery is not charged during the sleep mode. In addition, the controller can monitor the battery's temperature and disable the power regulator when the temperature is outside a predetermined temperature range. Similar to other battery parameters, the predetermined temperature range can be a programmable parameter that is stored in the controller using the standard interface. The status diode is dark when the power regulator is inactive (e.g., upon completion of charging the battery, during the sleep mode, or when the power regulator is disabled).

In one embodiment, the battery charging circuit includes a direction resistor configured for coupling between the battery and a battery terminal of the portable device. The controller monitors the direction resistor for current flow. Current flowing from the portable device to the battery indicates that an external power source (e.g., an AC adapter, a car adapter, or a USB interface) is connected to the portable device and attempting to charge the battery. Current flowing from the battery to the portable device indicates that the portable device is active. In some implementations, the controller disables the power regulator to avoid redundancy or conflict when the external power source (e.g., a substantially fixed DC power source) is available to charge the battery as indicated by the direction resistor. In some applications, the controller also selectively disables the power regulator to reduce EMI when the direction resistor indicates that the portable device (e.g., a cell phone) is active or being used.

For purposes of summarizing the embodiments and the advantages achieved over the prior art, certain items and advantages are described herein. Of course, it is to be understood that not necessarily all such items or advantages may be achieved in accordance with any particular embodiment. Thus, for example, those skilled in the art will recognize that the inventions may be embodied or carried out in a manner that achieves or optimizes one advantage or group of advantages as taught or suggested herein without necessarily achieving other advantages as may be taught or suggested herein.

### BRIEF DESCRIPTION OF THE DRAWINGS

A general architecture that implements the various features of the disclosed systems and methods will now be described with reference to the drawings. The drawings and the associated descriptions are provided to illustrate embodiments and not to limit the scope of the disclosure.

FIG. 1 is a block diagram of a solar chargeable battery system in accordance with one embodiment of the present invention.

FIG. 2 is a circuit diagram for one implementation of the solar chargeable battery system.

FIG. 3A illustrates an example communication device with a solar chargeable replacement battery package.

FIG. 3B illustrates one embodiment of a replacement battery kit with a solar chargeable battery for a portable device.

FIG. 4 illustrates a cross-sectional view of one embodiment of the solar chargeable replacement battery package.

FIG. 5 is a graph showing example battery voltages, regulated voltage levels, and charging currents as a function of time.

FIG. 6 is a graph showing example adjustments to a regulated voltage level in response to a variable source voltage.

Throughout the drawings, reference numbers are re-used to indicate correspondence between referenced elements. In addition, the first digit of each reference number indicates the figure in which the element first appears.

### DETAILED DESCRIPTION

The present invention relates to a method and an apparatus for charging a battery using a variable power source such as solar energy or light. While the specification describes several example embodiments of the invention, it should be understood that the invention can be implemented in many ways and is not limited to the particular examples described below or to the particular manner in which any features of such examples are implemented.

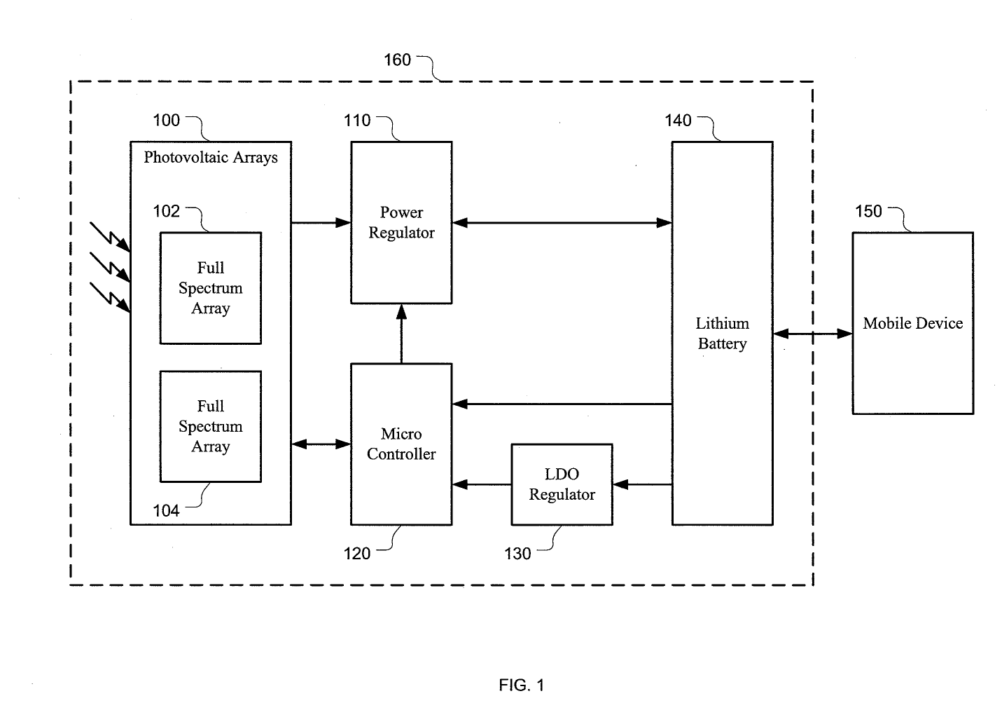

As described above, PV cells can be used to convert solar energy or light into electrical energy for charging a battery. FIG. 1 is a block diagram of one embodiment of a solar chargeable battery system 160 comprising a PV array 100 with one or more PV cells 102, 104. The PV array 100 outputs a substantially DC power source at a voltage level and a current level that vary with lighting conditions. For example, the voltage and/or current provided by the PV array 100 varies greatly depending upon the density and the wavelength of available light exposed to the PV cells 102, 104. The solar chargeable battery system 160 includes a programmable charge management circuit comprising a power regulator 110 and a microcontroller 120 to efficiently charge a battery 140 from the variable voltage/current DC power source provided by the PV array 100.

The PV cells 102, 104 of the PV array 100 can be single-junction PV cells, multi junction PV cells, or a combination of both. Particular embodiments of multi junction PV cells are discussed in further detail in commonly-owned pending U.S. application Ser. No. 12/389,307 (Attorney Docket No. SNCR.004A), entitled “Photovoltaic Multi-Junction Wavelength Compensation System and Method,” which is hereby incorporated by reference herein in its entirety.

In one embodiment, the power regulator 110 receives the substantially DC power source from the PV array 100 at an input terminal and provides a charging current to the battery 140 at an output terminal. The power regulator 110 also receives feedback signals from the battery 140 for voltage and/or current regulation. The microcontroller 120 monitors the substantially DC power source from the PV array 100 and provides one or more control signals to the power regulator 110. For example, one of the control signals selectively adjusts a regulated voltage level at the output terminal of the power regulator 110 in response to voltage variations of the substantially DC power source. The microcontroller 120 may also provide control signals to the PV array 100 to improve PV cell efficiency and reduce variations in the output of the PV array 100 as described in commonly-owned pending U.S. application Ser. No. 12/389,307 (Attorney Docket No. SNCR.004A).

In one embodiment, the microcontroller 120 configures the power regulator 110 to operate in different modes to efficiently charge and recharge the battery 140 under different lighting conditions. For example, the power regulator 110 is configured to operate in a first mode when the substantially DC power source is above a first predefined voltage threshold indicative of bright light conditions and in a second mode when the substantially DC power source is below the first predefined voltage threshold indicative of dim light conditions. The power regulator 110 operates with a predetermined regulated voltage level in the first mode. The power regulator 110 operates with a variable regulated voltage level in the second mode. The variable regulated voltage level is less than the predetermined regulated voltage level and allows the power regulator 110 to continue charging the battery 140 when available voltage and/or power from the PV array 100 decreases.

In other words, the microcontroller 120 dynamically adjusts the regulated voltage level at the output of the power regulator 110 to compensate for variations of the substantially DC power source at the output of the PV array 100. In one embodiment, the microcontroller 120 is powered by the battery 140 rather than the PV array 100 such that the microcontroller's operations are not affected by fluctuations at the output of the PV array 100. For example, a low drop-out (LDO) regulator 130 may be coupled to the battery 140 to generate a power source at an appropriate level for the microcontroller 120.

By way of example, the battery 140 can be a lithium based battery, such as a lithium-ion battery or a lithium-polymer battery used in many consumer electronic devices or a mobile communication device 150. In one embodiment, the solar chargeable battery system 160 comprising the battery 140, PV array 100, and charge management circuitry are integrated in an encapsulated or self-contained package having a substantially similar form factor as a standard battery package specified by a device manufacturer. This allows manufacturers or consumers to easily replace the standard battery package with the solar chargeable battery system 160 and enjoy the many benefits of solar energy. In one embodiment, the microcontroller 120 of the charge management circuitry is programmable to allow the manufacturers to configure the solar chargeable battery system 160 for difference devices and applications using a standard programming interface.

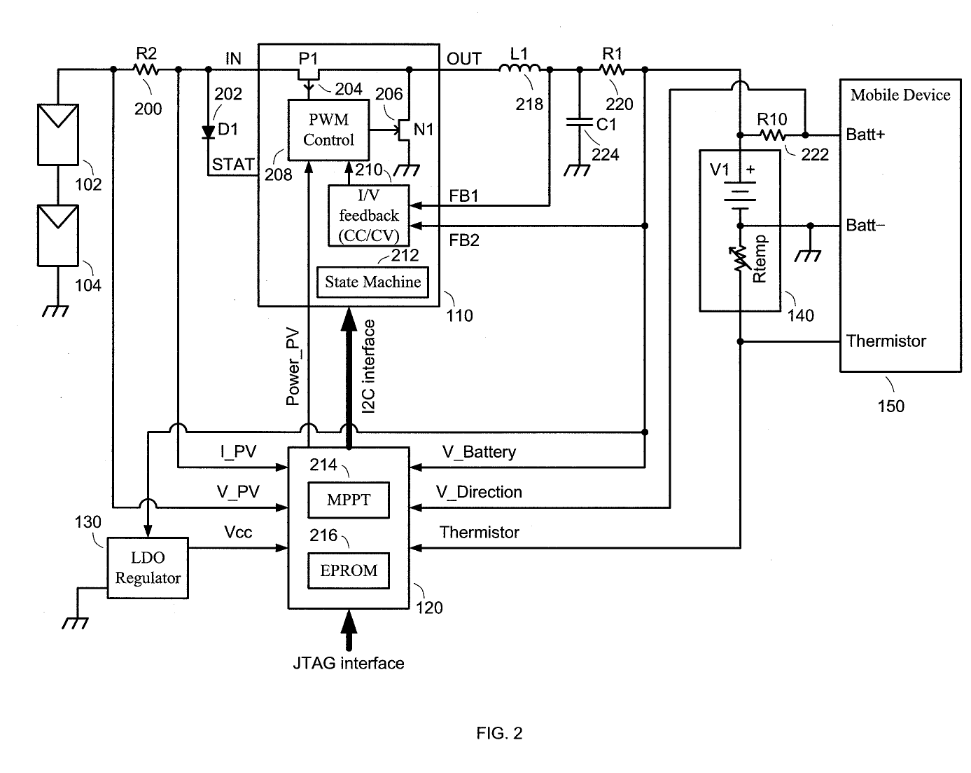

FIG. 2 is a circuit diagram for one implementation of the solar chargeable battery system 160. By way of example, the embodiment in FIG. 2 shows two PV cells 102, 104 connected in series to provide a variable DC power source having a nominal voltage range of 4.6V-5.0V for charging the battery 140. Less or more PV cells may be employed to generate the variable DC power source and other nominal voltage ranges are possible. A source sensing resistor (R2) 200 is coupled in series with the PV cells 102, 104 to an input terminal (IN) of a charge regulator 110. In one embodiment, the charge regulator 110 is a switching regulator (or synchronous buck converter) implemented with on-chip switching transistors (e.g., field-effect-transistors P1 and N1) 204, 206 and an off-chip inductor (L1) 218 coupled to an output terminal (OUT) of the charge regulator 110. An output sensing resistor 220 is coupled in series with the inductor 218 to a positive terminal of the battery 140. An output capacitor (C1) 224 is coupled between ground and a common node connecting the inductor 218 and the output sensing resistor 220.

The charge regulator 110 includes a pulse-width-modulation (PWM) circuit 208 and a feedback circuit 210. The feedback circuit 210 receives one or more feedback signals (e.g., FB1 and FB2) indicative of a charge current provided to the battery 140 and/or a battery voltage at the positive terminal of the battery 140. The feedback circuit 210 outputs one or more control signals to the PWM circuit 208 which generates driving signals for the switching transistors 204, 206 to regulate the charge current and/or the battery voltage. The feedback circuit 210 can be programmed to run different charging algorithms (e.g., CC/CV or chemical polarization) with programmable charge current profiles and voltage regulation levels. In one embodiment, the battery 140 is a lithium based battery for a mobile communication device 150 and the voltage regulation level is about 4.2V. The functions of the charge regulator 110 can be implemented with a programmable chip such as Texas Instruments bq24150.

In one embodiment, the charge regulator 110 further includes a state machine 212 configured to selectively operate the charge regulator 110 in different modes. For example, a microcontroller 120 monitors the variable DC power source and provides one or more control signals/commands to the charge regulator 110 to control the operating modes and operating parameters. The control signals/commands may be communicated to the charge regulator 110 directly via dedicated pins or through a standard interface such as an I²C interface. As described above, the microcontroller 120 monitors a voltage level (V_PV) of the variable DC power source to selectively operate the charge regulator 110 in a first mode with a substantially fixed regulated voltage when the variable DC power source is above a first predefined voltage threshold and in a second mode with an adjustable regulated voltage when the variable DC power source is below the first predefined voltage threshold.

In one embodiment, the microcontroller 120 also monitors a current level (I_PV) of the variable DC power source using the source sensing resistor 200. The microcontroller 120 uses a maximum power point tracking (MPPT) algorithm 214 to generate a duty-cycle control signal (Power_PV) to the PWM circuit 208 to further improve operating efficiency. The microcontroller 120 optionally inhibits or temporarily suspends operations of the charge regulator 110 when the variable DC power source provides relatively low power (e.g., based on detection of a predefined low current level or a predefined low voltage level).

The microcontroller 120 is powered by the battery 140 for reliable operations. Batteries typically have built-in protection for depleted batteries and have a minimum battery voltage (e.g., 2.7V). A LDO regulator 130 operates within a voltage range including the minimum battery voltage to reliably generate power (Vcc or about 1.8V) for the microcontroller 120. In one embodiment, the solar chargeable battery system including the microcontroller 120 enter a quiescent mode (or sleep mode) when the variable DC power source is not present or at a low level to prevent draining of the battery 140. In one application for charging lithium based batteries, the microcontroller 120 enters the sleep mode when the voltage level of the variable DC power source is less than the battery voltage. The microcontroller 120 continues to monitor the variable DC power source during the sleep mode but other functions are turned off to reduce power consumption.

In addition to monitoring the variable DC power source, the microcontroller 120 is configured to monitor other parameters (e.g., battery voltage and battery temperature) that affect charging operations. For example, the microcontroller 120 samples the battery temperature (Thermistor) and terminates charging operations if the battery temperature is outside a programmable temperature range (e.g., 0° C.-40° C.) deemed unsafe for charging. The microcontroller 120 is optionally configured to monitor the positive terminal of the battery 140 to perform battery chemistry analysis. In one embodiment, the microcontroller 120 is implemented by digital circuits and include one or more analog-to-digital converters (ADCs) to convert analog samples of the various parameters (e.g., I_PV, V_PV, V_Battery, V_Direction, Thermistor) into digital signals for further processing.

As mentioned above, the solar chargeable battery system can be embodied as a replacement battery package for portable devices such as a cell phone 150. A small sensing resistor (R10) 222 is coupled between the positive terminal of the battery 140 and a battery terminal of the cell phone 150 to detect current flow between the cell phone 150 and the battery 140. The microcontroller 120 monitors the voltage across the small sensing resistor (or direction resistor) 222 to determine the direction of the current flow. When the voltage (V_Direction) at the battery terminal of the cell phone 150 is higher than the voltage (V-Battery) at the positive terminal of the battery 140, an internal charger of the cell phone 150 is connected to an external power source (e.g., a wall adapter, a car charger or a USB port) and attempting to charge the battery 140 from a fixed voltage source. In this circumstance, the microcontroller 120 disables the power regulator 110 to avoid conflict or redundancy. Thus, the solar chargeable battery system does not impact the battery charging circuits that are already designed into the cell phone 150. As a replacement battery package, the solar chargeable battery system's interface to the cell phone 150 is simple and does not violate any of the cell phone's internal circuit functions.

In one embodiment, the small sensing resistor 222 is also used to detect when the cell phone 150 is active (or being used). For example, current flows from the battery 140 to the active cell phone 150. The voltage at the battery terminal of the cell phone 150 would be lower than the voltage at the positive terminal of the battery 140. Thus, the voltage across the small sensing resistor 222 has one polarity when the cell phone 150 is connected to an external source for charging the battery 140 and an opposite polarity when the cell phone 150 is active. In some applications, the microcontroller 120 disables the power regulator 110 when the voltage polarity of the small sensing resistor 222 indicates activity by the cell phone 150. As mentioned above, the power regulator 110 can be implemented as a switching regulator. If the cell phone 150 is susceptible to EMI, it may be beneficial to temporarily turn off the power regulator 110 to reduce EMI while the cell phone 150 is being used.

In one embodiment, the solar chargeable battery system includes a charging status diode 202 coupled between the input terminal and a status terminal (STAT) of the power regulator 110. The charging status diode 202 is a light emitting diode that lights up to indicate the battery 140 is being charged by the variable DC power source provided by the PV cells 102, 104. The charging status diode 202 is dark when the power regulator 110 is disabled or otherwise inactive. Additional status indicators can be included as desired for the various charging conditions discussed above.

The solar chargeable battery system is highly adaptable and can be easily configured to implement application specific requirements. For example, the microcontroller 120 has a standard interface (e.g., JTAG interface) for defining parameters such as the battery temperature range, battery regulation voltages, charging current levels, charging termination thresholds, and the like. In one embodiment, the parameter definitions are specified by the manufacturer and stored in flash memory (e.g., EPROM) 216 of the microcontroller 120 for reference during operations.

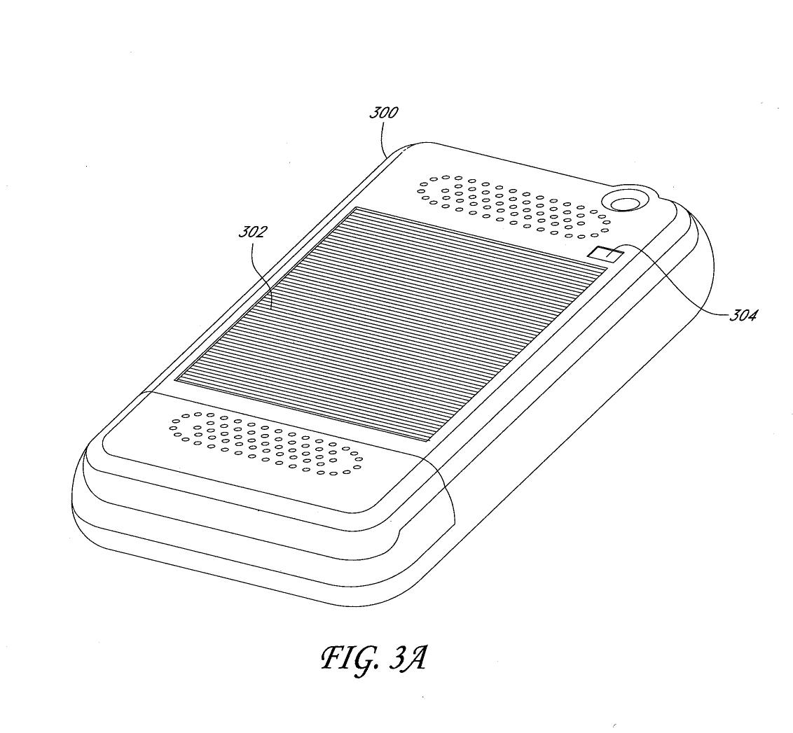

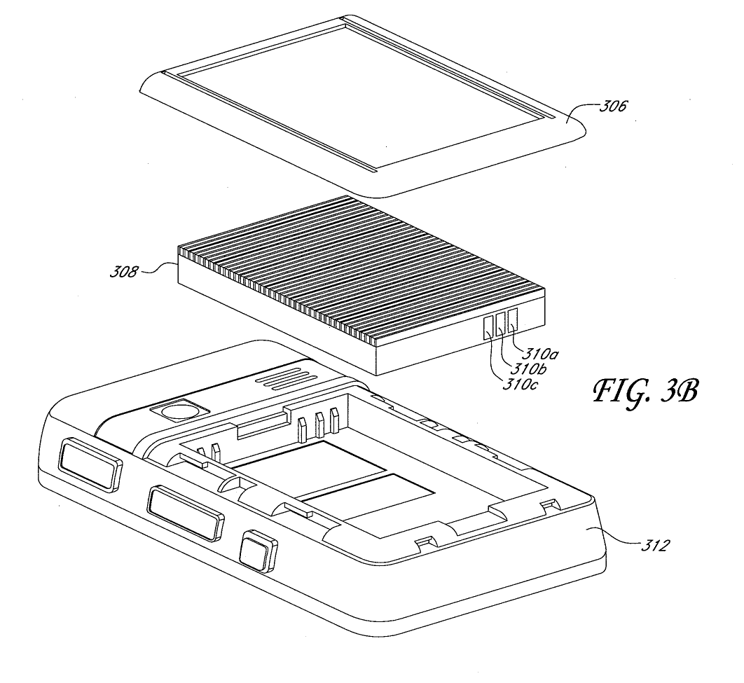

FIG. 3A illustrates an example communication device 300 with a solar chargeable replacement battery package 302. The solar chargeable replacement battery package 302 is a plug in replacement of a standard battery package for the communication device 300. That is, the solar chargeable replacement battery package 302 has a substantially similar form factor as the standard battery package specified by a manufacturer of the communication device 300. Thus, the overall dimensions of the communication device 300 do not change, but the solar chargeable replacement battery package 302 has an added flexibility of being chargeable by light. In some applications, a cover for the communication device 300 may be modified to ensure exposure of the PV cells 102, 104 to light. In addition, the cover may be modified to accommodate an opening 304 to view the charging status diode 202.

FIG. 3B illustrates one embodiment of a replacement battery kit with a solar chargeable battery 308 for a portable device 312. The replacement battery kit also includes a replacement cover 306. The replacement cover 306 has substantially similar outer dimensions as a standard cover specified by a manufacturer for the portable device 312 and an opening to expose PV cells of the solar chargeable battery 308 after installation in the portable device 312. For example, the replacement cover 306 can have a frame-like structure with a central opening. The solar chargeable battery 308 has substantially similar dimensions as a standard battery and includes similar electrical contacts (e.g., positive and negative battery terminals, a temperature sensing terminal) 310a, 310b, 310c to interface the portable device 312. Although not shown in FIG. 3B, the solar chargeable battery 308 can include a status diode in some applications and the replacement cover 306 can include a small opening for viewing the status diode.

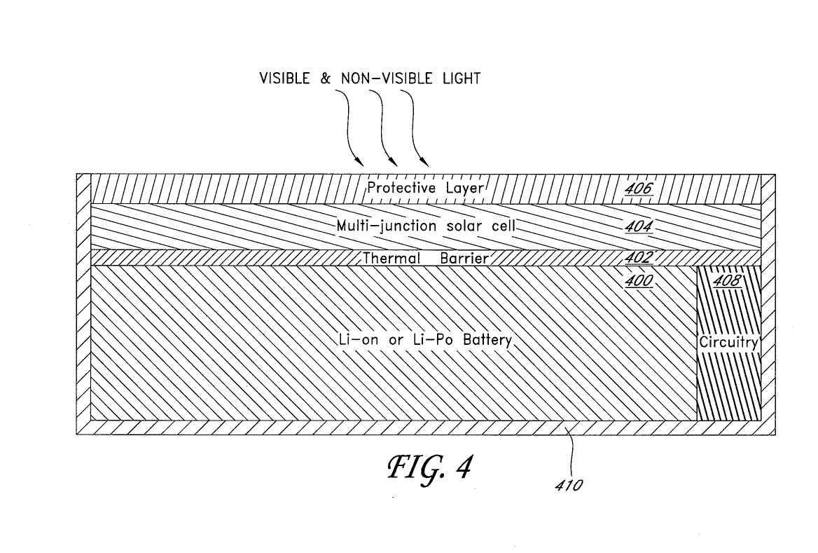

FIG. 4 illustrates a simplified cross-sectional view of one embodiment of a solar chargeable replacement battery package. The solar chargeable replacement battery package is a self-contained package comprising a battery layer 400, a PV array 404, and charge management circuitry 408. In one embodiment, an encapsulating epoxy potting compound 410 defines bottom and side surfaces of the solar chargeable replacement battery package. The battery layer 400 is placed inside the bottom surface. The PV array 404 is placed on top of the battery layer 400 and isolated from the battery layer 400 by a thermal barrier layer 402. The thermal barrier layer 402 provides thermal isolation between the battery layer 400 and the PV array 404 such that solar heat is not conducted to the battery layer 400 and battery heat is not conducted to the PV array 404. A protective layer 406 is placed on top of the PV array 404. The protective layer 406 is optically transparent (e.g., clear) to allow both visible and invisible light to reach the PV array 404 for converting into electrical energy. The protective layer 406 defines a top surface of the solar chargeable replacement battery package and combines with the encapsulating epoxy potting compound 410 to enclose the battery layer 400, the PV array 404, and the charge management circuitry 408.

The charge management circuitry 408 interfaces with the PV array 404 and charges the battery layer 400 from a variable DC power source provided by the PV array 404. In one embodiment, the charge management circuitry 408 occupies a portion of the battery layer 400. In some applications incorporating a status diode, a portion the charge management circuitry 408 may extend into the PV array 404 such that the status diode is viewable from the top surface. In some applications directed to mobile communication devices such as cell phones, the battery layer 400 is approximately 3.5 mm thick and comprises a lithium-ion or a lithium-polymer battery. The thermal barrier layer 402 comprises a polyimide film with a thickness of approximately 25 μm-50 μm to provide thermal insulation of up to 750° F. The PV array 404 comprises one or more single-junction or multi junction PV cells having a thickness of approximately 140 μm. The protective layer 406 has a thickness of approximately 60 μm -100 μm, preferably 70 μm-90 μm, and about 80 μm to provide impact resistance for the PV array 404. Other dimensions are possible to achieve application specific form factors for the solar chargeable replacement battery package.

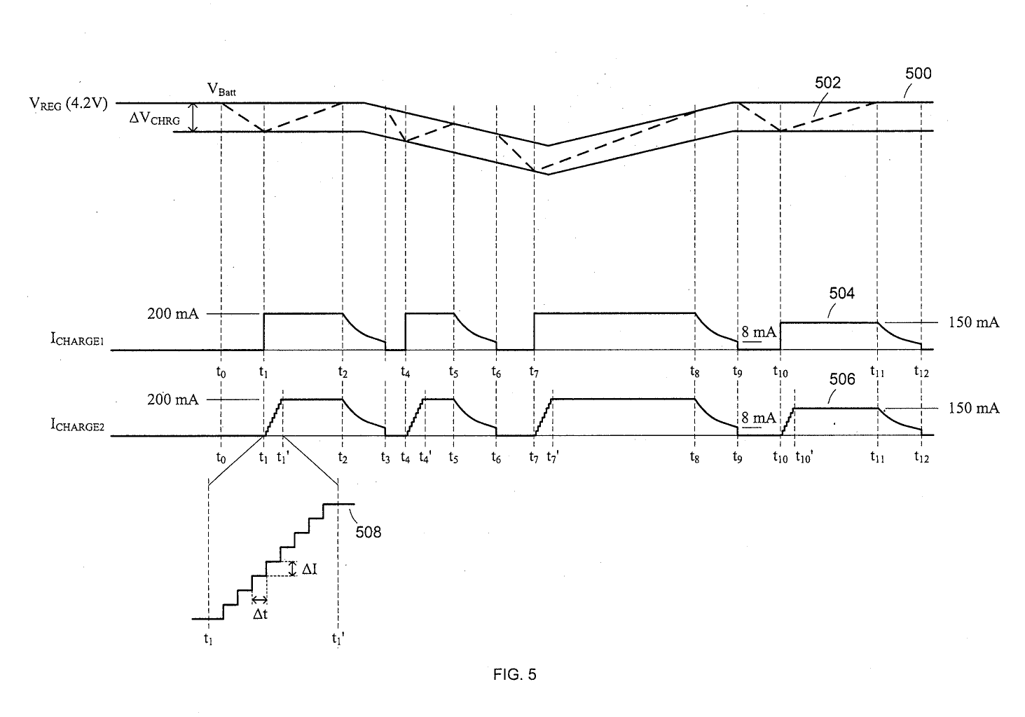

FIG. 5 is a graph showing example battery voltages, regulated voltage levels, and charging currents as a function of time when the power regulator 110 of the solar chargeable battery system is charging the battery 140 using a CC/CV algorithm. A graph 500 shows the regulated voltage levels (V_{REG}) as a function of time. A graph 502 shows the battery voltages (V_{Batt}) as a function of time. A graph 504 shows a first example charging current (I_{CHARGE1}) as a function of time. Finally, a graph 506 shows a second example charging current (I_{CHARGE2}) as a function of time.

As discussed above, the solar chargeable battery system operates with a substantially fixed regulated voltage level in a first mode and an adjustable regulated voltage level in a second mode. In the example shown in FIG. 5, the solar chargeable battery system is operating in the first mode during times t₀-t₂ and t₉-t₁₂ and in the second mode during time t₃-t₈. The regulated voltage levels shown in the graph 500 is substantially fixed (e.g., about 4.2V) in the first mode and varies (e.g., changes with time below 4.2V) in the second mode. The battery voltages shown in the graph 502 fluctuate between the regulated voltage levels and a battery recharge threshold. In one embodiment, the battery recharge threshold changes with the regulated voltage levels and is approximately 100 mV-150 mV (or about 120 mV) below the regulated voltage levels.

The CC/CV algorithm includes interleaving current regulation phases and voltage regulation phases. The power regulator 110 charges the battery 140 with a substantially constant battery charging current during the current regulation phases and a decreasing battery charging current during the voltage regulation phases. Referring to the graph 504, the current regulation phases occur during times t₁-t₂, t₄-t₅, t₇-t₈, and t₁₀-t₁₁ while the voltage regulation phases occur during times t₂-t₃, t₅-t₆, t₈-t₉, and t₁₁-t₁₂.

A current regulation phase is triggered (or started) when the level of the battery voltage reaches the battery recharge threshold (e.g., at times t₁, t₄, t₇, and t₁₀). The level of the battery voltage increases (e.g., linearly) with time while the battery 140 is charged with the substantially constant battery charging current during the current regulation phase. In one embodiment, the level of the substantially constant battery charging current is programmable (e.g., by the manufacturer). In some applications for the lithium based batteries, the level of the substantially constant battery charging current is about 200 mA. In some implementations, the microcontroller 120 monitors the variable DC power source provided by the PV array 100 and reduces the level of the substantially constant battery charging current when the current level of the variable DC power source is less than a predefined current threshold (e.g., during time t₁₀-t₁₁). The current regulation phase ends (or stops) when the level of the battery voltage reaches the level of the regulated voltage (e.g., at times t₂, t₅, t₈, and t₁₁).

A voltage regulation phase follows each current regulation phase. The charging current decreases during the voltage regulation phase to maintain the battery voltage at approximately the regulated voltage level. The voltage regulation phase ends when the charging current reaches a predetermined termination level (e.g., at times t₃, t₆, t₉, and t₁₂). In one embodiment, the predetermined termination level is programmable (e.g., between 8 mA-64 mA in predefined steps of 8mA) and defined by the manufacturer for each specific device. After the voltage regulation phase ends, the power regulator 110 enters an idle phase in which no charge current is provided to the battery 140 and the battery voltage decreases at a rate that is dependent on usage of the mobile device 150. When the battery voltage reaches the battery recharge threshold, the power regulator 110 starts another current regulation phase.

The second example charging current (I_{CHARGE2}) shown in the graph 506 is substantially similar to the first example charging current (I_{CHARGE1}) shown in the graph 504, except the second example charging current includes a soft-start transition at the beginning of each current regulation phase. A graph 508 shows an expanded view of the soft-start transition between time t₁-t_{1′}. The soft-start transition is a stepped rising edge comprising a plurality of incremental current steps. In one embodiment, the step sizes (ΔI) and intervals (Δt) are programmable and controlled by the microcontroller 120. The soft-start transition helps to reduce EMI.

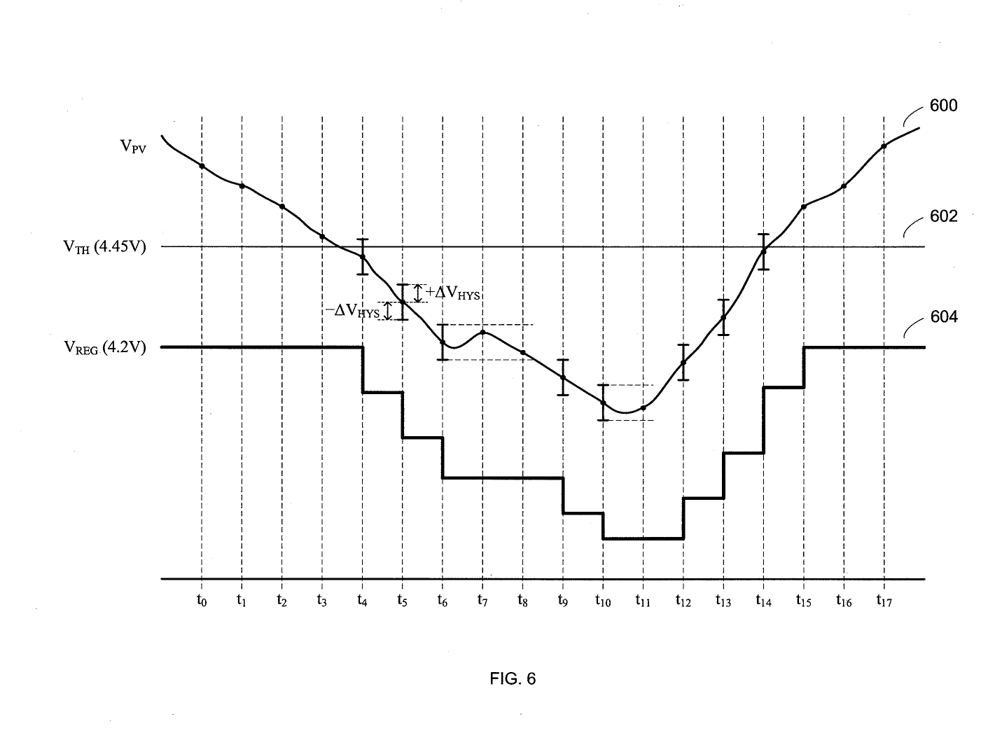

FIG. 6 is a graph showing example adjustments to a regulated voltage level in response to a variable source voltage. A graph 600 shows the variable source voltage (V_{PV}) as a function of time. A graph 604 shows the regulated voltage level (V_{REG}) as a function of time. As discussed above, the microcontroller 120 monitors the variable source voltage provided by the PV array 100 and selectively adjusts the regulated voltage level of the power regulator 110 with reference to a predefined voltage threshold (V_{TH}) 602. In one embodiment, the microcontroller 120 is a digital circuit and adjusts the regulated voltage level in discrete steps. If desired, additional filtering can be used to smooth the discrete steps and make the graph 604 appear more like the graph 500 in FIG. 5.

In the example shown in FIG. 6, the microcontroller 120 samples the variable source voltage at each of the marked times. At times t₀-t₃ and t₁₅-t₁₇, each sample of the variable source voltage is above the predefined voltage threshold (e.g., 4.45V) and the power regulator 110 operates in the first mode with a substantially fixed regulated voltage level (e.g., 4.2V). Between times t₄ and t₁₄, each sample of the variable source voltage is below the predefined voltage threshold and the power regulator 110 operates in the second mode with an adjustable regulated voltage level that tracks the variable source voltage. For example, the adjustable regulation voltage level is approximately equal to the sampled level of the variable source voltage less a predetermined amount (e.g., about 250 mV). The predetermined amount is programmable by the manufacturer for specific devices or applications.

In the example shown in FIG. 6, the microcontroller 120 uses hysteresis in the second mode and the adjustable regulation voltage level is not updated when a subsequent sample of the variable source voltage is within the hysteresis (e.g., +/−ΔV_{HYS}). For example, samples of the variable source voltage at times t₇ and t₈ are within the hysteresis of the sample taken at time t₆, and the adjustable regulated voltage level stays at the level set at time t₆. Similarly, the sample of the variable source voltage at time t₁₁ is within the hysteresis of the sample taken at time t₁₀, and the adjustable regulated voltage level is not updated. The hysteresis helps to reduce unnecessary updates to the adjustable regulation voltage level and thus reduce system noise that may produce EMI in sensitive applications such as cell phones. In one embodiment, the hysteresis level is programmable and is about +/−30 mV in some applications.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions, and changes in the form of the methods and systems described herein may be made without departing from the spirit of the inventions. The accompanying claims and their equivalents are intended to cover such forms or modifications as would fall within the scope and spirit of the inventions.

What is claimed is:

1. A battery charging circuit for a portable device comprising:
a switching regulator configured to receive a substantially DC power source from one or more photovoltaic cells at an input terminal and to charge a battery coupled to an output terminal; and
a controller configured to monitor the substantially DC power source and to provide one or more control signals to the switching regulator to selectively operate the switching regulator in a first mode when a voltage level of the substantially DC power source is above a first predefined voltage threshold and in a second mode when the voltage level of the substantially DC power source is below the first predefined voltage threshold, wherein the switching regulator operates with a predetermined regulated voltage level in the first mode and operates with a variable regulated voltage level that tracks the voltage level of the substantially DC power source in the second mode.

2. The battery charging circuit of claim 1, wherein the substantially DC power source comprises at least two photovoltaic cells connected in series.

3. The battery charging circuit of claim 1, wherein the battery comprises a lithium-ion or a lithium polymer battery.

4. The battery charging circuit of claim 1, wherein the switching regulator charges the battery using a constant-current/constant-voltage algorithm comprising interleaving current regulation phases and voltage regulation phases, the switching regulator provides a substantially constant battery charging current during the current regulation phases, the substantially constant battery charging current has a predetermined current level when a current level of the substantially DC power source is above a predefined current threshold, and the substantially constant battery charging current has an adjusted current level that is approximately equal to the current level of the substantially DC power source when the current level of the substantially DC power source is below the predefined current threshold.

5. The battery charging circuit of claim 4, wherein the substantially constant battery charging current has a stepped rising edge near a beginning of each current regulation phase and the stepped rising edge comprises a plurality of incremental current steps with programmable step sizes and intervals.

6. The battery charging circuit of claim 4, wherein the switching regulator provides a decreasing battery charging current during the voltage regulation phases and stops charging the battery in the voltage regulation phases when the decreasing battery charging current reaches a termination current level.

7. The battery charging circuit of claim 6, wherein the termination current level, the predetermined current level of the substantially constant battery charging current, and the predetermined regulated voltage level are programmable parameters that are stored in the controller using a standard interface.

8. The battery charging circuit of claim 1, further comprising a direction resistor coupled between the portable device and the battery, wherein the controller monitors the direction resistor to disable the switching regulator when current flow is detected from the portable device to the battery.

9. The battery charging circuit of claim 1, further comprising a direction resistor coupled between the portable device and the battery, wherein the controller monitors the direction resistor to disable the switching regulator when current flow is detected from the battery to the portable device.

10. The battery charging circuit of claim 1, further comprising a status diode coupled between the substantially DC power source and a status pin of the switching regulator, wherein the status diode lights up while the switching regulator is charging the battery.

11. The battery charging circuit of claim 1, wherein the controller monitors the battery's temperature and disables the switching regulator when the battery's temperature is outside a predetermined temperature range, and the predetermined temperature range is a programmable parameter that is stored in the controller using a standard interface.

12. The battery charging circuit of claim 1, wherein the switching regulator and the controller enter a sleep mode when the voltage level of the substantially DC power source is less than the battery's voltage.

13. A method to charge a battery from a variable DC power source, the method comprising:
sensing a voltage level of the variable DC power source, wherein the variable DC power source is provided by a photovoltaic array;
selectively operating in a first mode when the voltage level of the variable DC power source is above a predefined voltage threshold, wherein the variable DC power source charges the battery to a predetermined regulated voltage level in the first mode and the predetermined regulated voltage level is approximately 4.2 volts; and
selectively operating in a second mode when the voltage level of the variable DC power source is below the predefined voltage threshold, wherein the variable DC power source charges the battery to an adjustable regulated voltage level in the second mode and the adjustable regulated voltage level is approximately equal to the voltage level of the variable DC power source less a predetermined amount.

14. The method of claim 13, wherein the photovoltaic array is integrated with the battery and isolated from the battery by a thermal layer.

15. The method of claim 13, further comprising sensing the battery's temperature, wherein the battery stops charging when the battery's temperature exceeds a predefined temperature threshold.

16. The method of claim 13, wherein the battery is installed in a device connectable to a substantially fixed DC power source and the variable DC power source stops charging the battery when the substantially fixed DC power source is connected.

17. A battery charger comprising:
a power regulator configured to receive a variable DC power source and to charge a battery; and
a controller configured to sense the variable DC power source, to operate the power regulator in a first mode when a voltage of the variable DC power source is above a predefined voltage level, and to operate the power regulator in a second mode when the voltage of the variable DC power source is below the predefined voltage level, wherein the power regulator charges the battery to a substantially fixed regulated voltage level in the first mode and to an adjustable regulated voltage level in the second mode.
